(19) United States
(12) Patent Application Publication
(10) Pub. No.: US 2007/0233353 A1
(43) Pub. Date: Oct. 4, 2007

(54) Enhanced adaptive cruise control system with forward vehicle collision mitigation

(76) Inventor: Alexander Kade, Grosse Pointe Woods, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/391,053

(22) Filed: Mar. 28, 2006

(51) Int. Cl. B60T 7/12

(52) U.S. Cl. 701/96

(57) ABSTRACT

An adaptive cruise control system includes a yaw rate sensor for generating a first radius of curvature calculation representing a first projected vehicle path for the automobile, an optical sensor for generating optical sensory data and for generating a second radius of curvature calculation representing a second projected vehicle path for the automobile. A vehicle path calculation module is coupled to receive the first and second radius of curvature calculations and, responsive thereto, to weigh and combine the first and second radius of curvature calculations, and to thereby generate a third radius of curvature calculation representing a third projected vehicle path, and to produce modified yaw rate sensor data therefrom. A vehicle control module is coupled to receive the modified yaw rate sensor data and to control automobile maneuvering functions in response thereto.

### TECHNICAL FIELD

The present invention generally relates to automobile cruise control systems, and more particularly relates to adaptive cruise control systems which have varying degrees of interaction with surrounding vehicles and/or objects.

### BACKGROUND OF THE INVENTION

Conventional cruise control systems regulate vehicle speed according to a speed setting that a vehicle operator may set and adjust while driving. Some cruise control systems have varying degrees of interaction with preceding vehicles. A general objective of adaptive cruise control systems is to sense moving in-path objects such as preceding vehicles, and to provide throttle and/or brake control to maintain a predetermined distance therefrom. Such systems are characterized by passive deceleration, meaning deceleration is effectuated by a closed-throttle coast.

One inherent limitation in current adaptive cruise control systems is an inability to adequately sense and react to in-path objects on winding roads. Advanced adaptive cruise control systems incorporate a yaw rate sensor to project the host vehicle path. However, the projection is typically not accurate when the roadway includes segments having a radius of curvature that is less than about 500 meters, particularly upon entering a curved segment from a straight segment, or when the road curvature is irregular or winding.

Further, current adaptive cruise control systems are unable to adequately respond to stationary in-path objects. Adaptive cruise control systems recognize all objects merely as reflected energy distributions, and consequently are unable to ignore some stationary objects such as bridges, overhanging road signs, and guard rails and distinguish such expected stationary objects from obtrusive stationary objects such as stalled vehicles, boulders, or pedestrians.

Accordingly, there is a need for an automobile adaptive cruise control system that is able to distinguish between various categories of stationary objects and react appropriately to those with which the automobile that pose a threat. There is also a need for a system that dependably and appropriately identifies and reacts to both moving and stationary objects on winding roadways.

### SUMMARY OF THE INVENTION

According to a first embodiment, an adaptive cruise control system for an automobile is provided. The adaptive cruise control system includes a yaw rate sensor for generating a first radius of curvature calculation representing a first projected vehicle path for the automobile, an optical sensor for generating optical sensory data and for generating a second radius of curvature calculation representing a second projected vehicle path for the automobile. A vehicle path calculation module is coupled to receive the first and second radius of curvature calculations and, responsive thereto, to weigh and combine the first and second radius of curvature calculations, and to thereby generate a third radius of curvature calculation representing a third projected vehicle path, and to produce modified yaw rate sensor data therefrom. A vehicle control module is coupled to receive the modified yaw rate sensor data and to control automobile maneuvering functions in response thereto.

In one exemplary embodiment, the adaptive cruise control system further includes a radar sensor for detecting objects in a radar sensory field, and generating object identification and velocity data. An object detection module is coupled to receive the object identification data and velocity data, and to determine whether the objects identified by the radar sensor are positioned in the third projected vehicle path.

According to a second embodiment, an adaptive cruise control method for an automobile is provided. A first radius of curvature calculation is generated representing a first projected vehicle path for the automobile using data from a yaw rate sensor. A second radius of curvature calculation is also generated representing a second projected vehicle path for the automobile using data from an optical sensor. The first and second radius of curvature calculations are weighed and combined to generate a third radius of curvature calculation representing a third projected vehicle path. Modified yaw rate sensor data is then generated using the third radius of curvature calculation. Automobile maneuvering functions are then controlled in response to the modified yaw rate sensor data.

According to another exemplary embodiment, the method further includes detecting objects in a radar sensory field using a radar sensor, and generating object identification and velocity data therefrom. Using the object identification and the velocity data, it is determined whether the objects identified by the radar sensor are positioned in the third projected vehicle path.

### DESCRIPTION OF THE DRAWINGS

The present invention will hereinafter be described in conjunction with the following drawing figures, wherein like numerals denote like elements, and

FIG. 1 is a top view depicting a vehicle on a roadway, along with radar sensory fields and vision fields generated using an adaptive cruise control system according to an exemplary embodiment of the present invention;

FIG. 2 is a block diagram that outlines an exemplary algorithm for executing a sensory fusion adaptive cruise control function;

FIG. 3 is a block diagram outlining an exemplary method for calculating a vehicle path using radar sensory field data and vision field data; and

FIG. 4 is a block diagram outlining an exemplary method for determining whether enhanced or forward vehicle collision modes should be employed to prevent a collision between an identified object and the vehicle.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

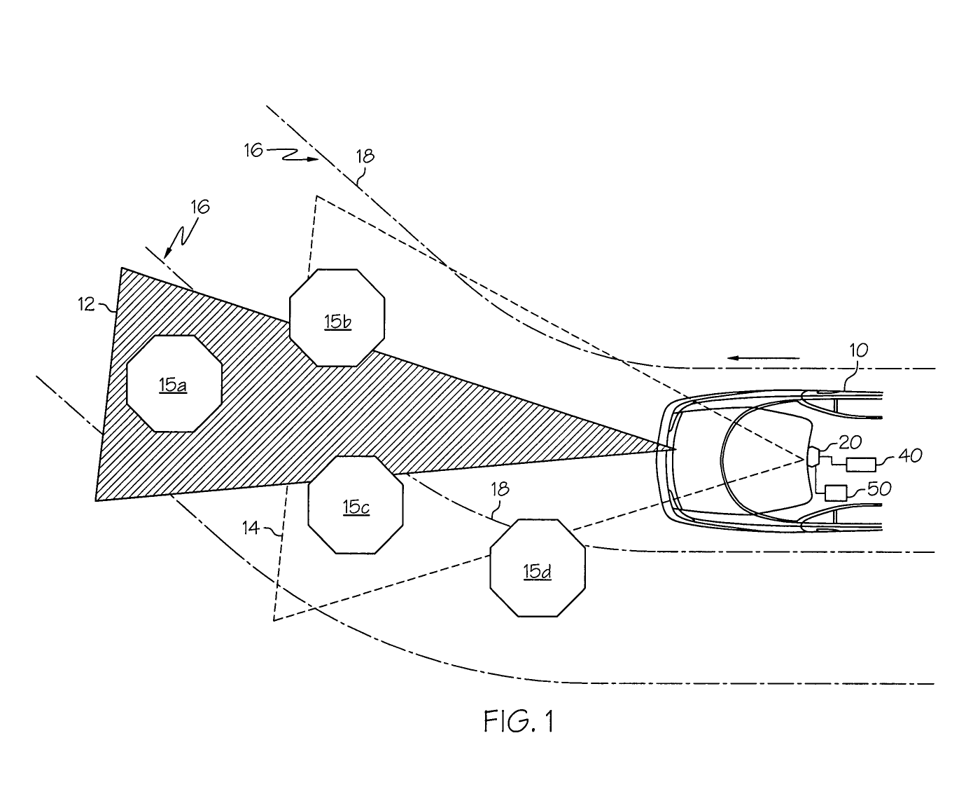

FIG. 1 is a top view of an automobile 10 traveling on a roadway. As depicted, the automobile 10 is on a straight roadway segment and is traveling in the direction indicated by the arrow alongside the automobile 10. The moving automobile 10 is approaching a curved roadway segment, and will need to turn to the right in order to remain in the designated vehicle pathway 16, which is distinguished by lane markers 18 that ordinarily are painted continuous and/or discontinuous lines.

The automobile 10 is equipped with an adaptive cruise control system that includes a radar system and a vision system that work together to determine the projected vehicle pathway 16 and also to identify and discriminate between various objects 15a-15d. The radar system sensory field is represented by the triangle 12, and the vision system sensory field is represented by the triangle 14. The triangles 12 and 14 are depicted for illustrative purposes only, and do not represent the actual size of or relationship between the sensory fields for the radar and vision systems.

Some conventional adaptive cruise control systems utilize data from a yaw rate sensor to adjust the radar system sensory field. A yaw rate sensor detects the yaw rate of the vehicle about its center of gravity. The yaw rate is the rotational tendency of the vehicle about an axis normal to the surface of the road. Although the yaw rate sensor may be located at the vehicle's center of gravity, those skilled in the art will appreciate that the yaw rate sensor may instead be located in various locations of the vehicle, and measurements may be translated back to the center of gravity either through calculations at the yaw rate sensor or using another processor in a known manner. Reviewing FIG. 1, when the automobile 10 begins to turn right along the vehicle path 16, a yaw rate sensor in a conventional adaptive cruise control system will sense a change in the vehicle's center of gravity and input the change into a processor. The yaw rate sensor may also input data regarding the vehicle velocity. In response to the yaw rate inputs, the processor may instruct the radar sensor to shift to the right so the sensory field 12 more closely follows the vehicle path 16 instead of being directly in front of the automobile 10. Further, the processor may determine from the yaw rate sensor that certain objects in the sensory field 12 are not in the vehicle path 16 and therefore ignore some identified objects that do not raise a threat of an impending collision.

A radar sensor identifies any object in the sensory field 12 and determines the object's velocity relative to the automobile 10. Reviewing FIG. 1, three objects 15a-15c are within the immediate radar sensory field 12. With a conventional adaptive cruise control system, the automobile 10 has not yet begun turning, and the input from the yaw rate sensor has not caused the sensory field to shift or given rise for a processor to ignore certain identified objects. Thus, the conventional adaptive cruise control system may appropriately react to the object 15b if it were a stationary object or an automobile traveling in the same direction as the automobile 10 in the vehicle path 16. However, the conventional adaptive cruise control system may not identify objects 15a and 15c as automobiles traveling outside of the vehicle path 16. If the objects 15a and 15c are automobiles traveling in an opposite direction to that of the automobile 10, the conventional adaptive cruise control system may undesirably activate crash mitigation systems such as releasing the throttle and/or activating a braking response even though the objects 15a and 15c do not pose a threat of a collision if the automobile 10 remains in the vehicle path 16. In addition, if object 15b is a stationary object such as a bridge or an overhanging sign, the conventional adaptive cruise control system may undesirably activate crash mitigation systems even though the object 15b does not pose a collision threat.

In order to improve the ability for an adaptive cruise control system to accurately recognize and react to objects and approaching changes in the vehicle pathway, an exemplary adaptive cruise control system further employs the vision system that utilizes a camera or other optical device that generates a visual input representing the visual field 14. The visual input is combined with the radar input to determine a projected vehicle pathway that a as nearly as possible matches the vehicle path 16, and also to identify and discriminate between various objects 15a-15d.

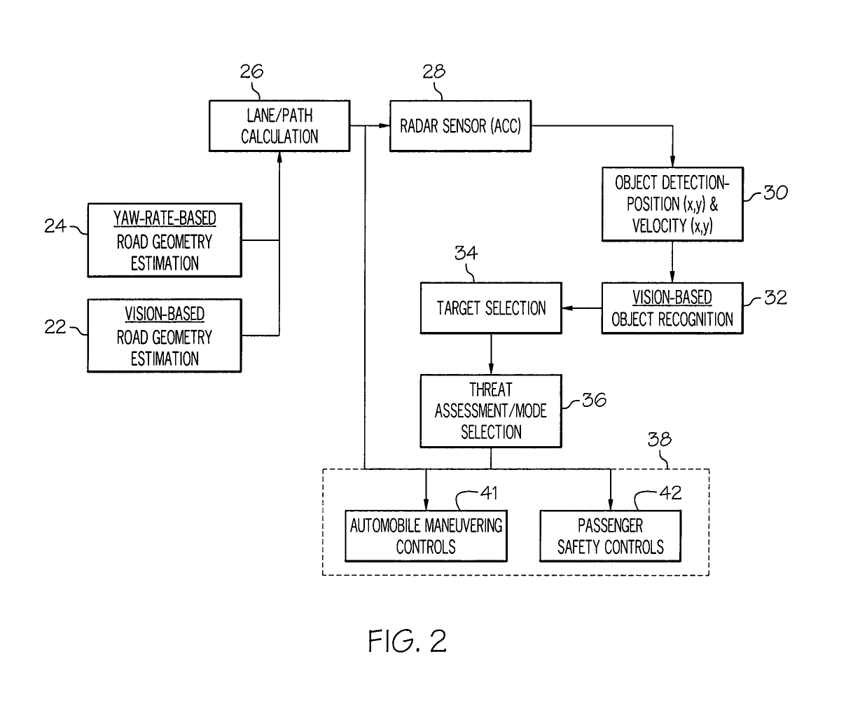

Referring now to FIG. 2, a block diagram depicts an algorithm for performing a radar-vision-yaw rate sensory fusion adaptive cruise control function. Each of the blocks in the diagram represents a module for performing a function. The modules may be components of a single on-board processor. Alternatively, one or more of the modules may be elements of different on-board processors, the data from each module being combined as represented in the diagram.

Under the sensory fusion algorithm, radar is the primary sensor and is capable of recognizing a plurality of objects in its field of view. For each object, the radar provides longitudinal and lateral positions, and relative closing velocities. Based on the radar-based object-related data, an initial threat assessment is performed and initial object priority is assigned to each object. Vision sensory data is also used to provide road geometry information. The vision sensory data is also used to improve and correct data in the yaw rate sensor signal for upcoming curves and other complex roadway patterns. Further, the vision sensory data is used to recognize and discriminate between objects detected by the radar sensor, and to determine if the radar identification of the lead vehicle or other target object is correct. Using the vision sensory data, the initial radar object priority is evaluated and reassigned as necessary. If the vision system is unable to provide useful data, the fusion system will operate as a conventional radar-based adaptive cruise control system, and may alert the driver of the reduced performance.

According to the algorithm outlined in FIG. 2, a vision-based road geometry estimation is performed using the module 22 based on inputs from a camera 20 depicted in FIG. 1 or other optical input. To estimate road geometry, the camera 20 inputs data into the module 24 such as information regarding lane markings on the roadway. In addition, the camera 20 obtains information regarding the lateral and vertical location of various objects, the dimensions for the identified objects, and an estimation of what each object is (i.e., a vehicle, bridge, overhead sign, guardrail, person) when possible.

A yaw rate-based road geometry estimation is also performed using the module 24 based on inputs from a yaw rate sensor 40 depicted in FIG. 1. As previously discussed, inputs from the yaw rate sensor may include changes in the vehicle center of gravity and the vehicle velocity. A vehicle path calculation is then performed using a module 26 that is responsive to both road geometry estimations and camera input regarding various objects along the roadway.

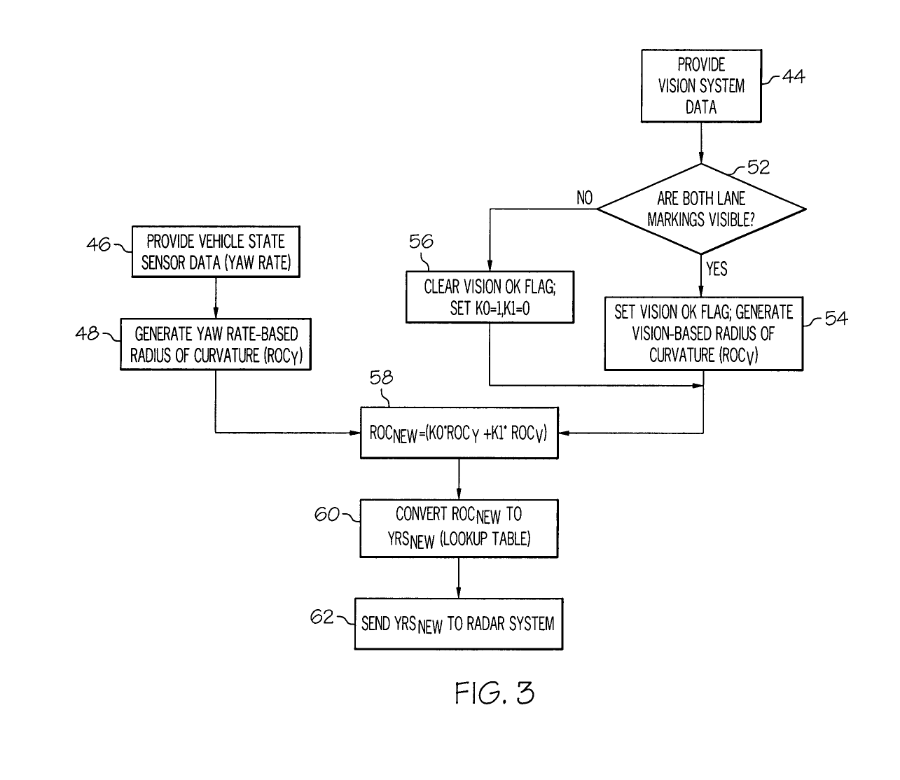

FIG. 3 is a block diagram outlining an exemplary method for calculating the vehicle path using the module 26. At step 46, data regarding the vehicle state is provided from the yaw rate sensor. Based on such factors as the vehicle's present center of gravity and velocity, a yaw rate-based radius of curvature (ROC_{Y}) that corresponds to a projected vehicle pathway that the automobile 10 is expected to be approaching is generated as step 48. Simultaneous with the generation of the ROC_{Y}, a vision-based radius of curvature (ROC_{V}) is generated. Vision sensory data is provided as step 46, and an immediate determination is made as step 52 regarding the data's value based on whether lane markings can be detected on the roadway using the data. If no lane markings are visible, a flag that allows the data to be used to calculate the vehicle path is cleared as step 56 and the vision sensory data is assigned no weight in the vehicle path calculation. If lane markings are available, the flag is maintained and the ROC_{Y} is generated as step 54.

At step 58, the ROC_{V} and ROC_{Y} are combined and weighed as appropriate to generate a new radius of curvature (ROC_{NEW}) that represents a newly projected vehicle pathway. The ROC_{Y} and ROC_{V} are weighed by assigning them weight constants, respectively K₀ and K₁, wherein K₀+K₁=1. Then, the ROC_{NEW} is calculated by adding (K₀*ROC_{Y}+K₁*ROC_{V}). As previously mentioned, if no lane markings were detected using the vision data, then the data is not flagged for use and consequently K₁=0 and K₀=1. If the lane markings are detected for only a short distance, then K₀>K₁. Also, if the automobile is presently going straight and the yaw rate sensor consequently does not detect any shift in the automobile's center of gravity, but the upcoming lane markings detected using the vision data represent an upcoming winding road, then K₁>K₀. If both the yaw rate data and vision data are evaluated as accurate and dependable, then both K₀ and K₁ might approximately equal about 0.5. Next, the yaw rate sensor data is adjusted to an adjusted value YRS_{NEW} using the newly calculated ROC_{NEW}.

Returning to FIG. 2, after calculating the vehicle path at step 26, the vehicle control system 38 receives and responds to the adjusted YRS_{NEW}. The vehicle control system 38 comprises automobile maneuvering controls 41 and passenger safety controls 42. Exemplary automobile maneuvering controls 41 include braking and throttle controls. Steering controls may be included in other exemplary automobile maneuvering controls 41. For example, if the vehicle path calculation reveals that the automobile is going too fast to safely maneuver along an upcoming road curvature, then braking and/or throttle controls may be activated to slow the automobile to a safe speed. Exemplary passenger safety controls include audible and/or visual warnings, and active passenger seats and/or seatbelts.

The adjusted YRS_{NEW} is also received by a radar sensor module 28 that, in response, adjusts the radar sensor 50 so the upcoming vehicle path 16 is within the radar sensory field 12. The radar sensor 50 identifies any object in the adjusted sensory field 12 and determines the object's velocity relative to the automobile 10 using an object detection module 30. The object's velocity is determined in at least two directions (xᵥ,yᵥ) wherein xᵥ is the direction approaching the automobile and yᵥ is a direction perpendicular to xᵥ. The radar sensor 50 also is configured to determine the object's position (xₚ, yₚ) using the radar-based object detection module 30, wherein xₚ is the direction approaching the automobile and yₚ is a direction perpendicular to xₚ, and thereby determine if the object is in the vehicle path 16, including both the horizontal and the vertical portions of the vehicle path.

Upon detecting the object positions and relative velocities, data from the camera 20 is used to recognize particular objects as automobiles, bridges, signs, rail guards, pedestrians, etc. using the vision-based object recognition module 32. The module 32 is configured to recognize objects based on their shapes and sizes, and locations with respect to the vehicle path 16. The module 32 is configured to recognize objects that may have been detected by the camera 20 but not by the radar 50, such as object 15d in FIG. 1 that is within the visual field 14 but outside the radar field 12.

After detecting and recognizing the various objects using the radar-based module 30 and the vision-based module 32, a target selection module 34 correlates the object detection, velocity, and recognition data. The module 34 prioritizes each identified object according to the object's position with respect to the vehicle. More particularly, the module 34 uses the radar-based object detection and velocity data and prioritizes each object according to its proximity to the automobile 10 and its relative velocity. The module 34 then correlates the highest priority object with the corresponding vision-based object recognition data and tests whether the object is in or out of the vehicle path 16. Turning to FIG. 1, the highest priority object would be object 15d in an exemplary embodiment because the object 15d is nearest to the automobile. The module 34 would determine that the object 15d is slightly inside the vehicle path 16 and would immediately allow for a threat assessment for the object using a threat assessment module 36. The module 34 would then turn to the next highest priority object, and each additional identified object, disregarding those objects that are outside of the vehicle path 16. For example, the module 34 would determine that objects 15a and 15c are not immediately within the vehicle path 16. If the object 15b is determined to be a stationary or moving object such as a vehicle, then the module 34 would immediately allow for a threat assessment using the threat assessment module 36.

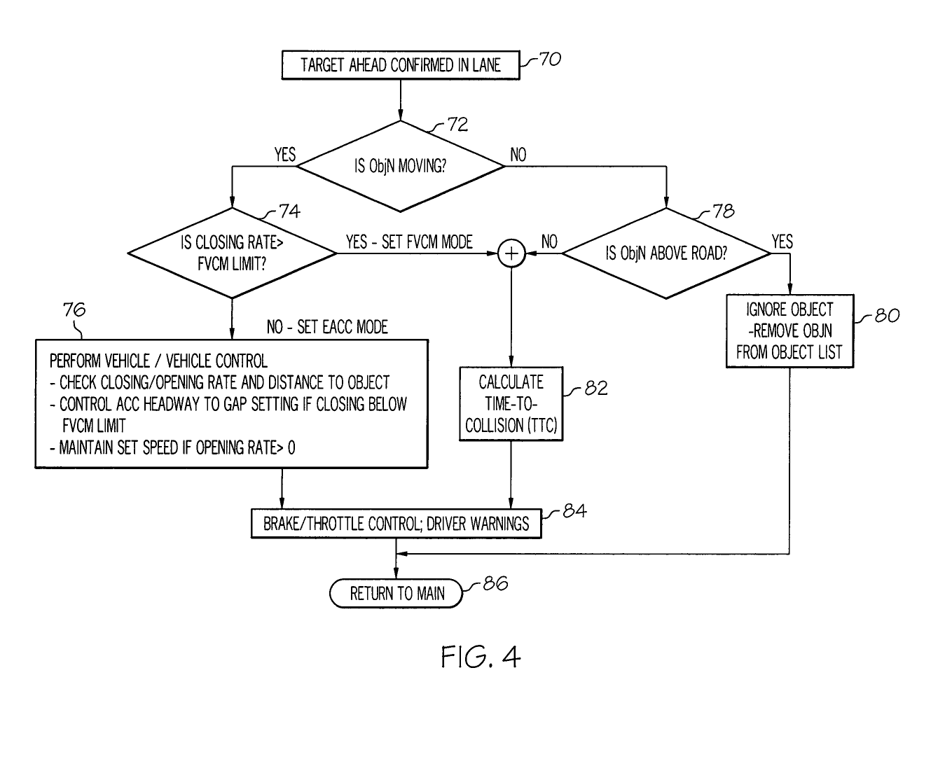

A block diagram outlining an exemplary threat assessment method is depicted in FIG. 4. The threat assessment module 36 determines whether a normal enhanced adaptive cruise control mode (EACC mode) or a forward vehicle collision mitigation mode (FVCM mode) should be employed to prevent a collision between an identified object and the automobile 10. At step 70, data representing that an object is in the vehicle path 16 is received by the threat assessment module 36. Based on the radar data, a decision is made based on whether the object is moving at step 72. If the object is not moving, then a decision is made at step 78 based on the vision data regarding whether the object is a bridge, overhead sign, or otherwise disposed substantially high above the road to be non-threatening. If the object is sufficiently high above the road to be non-threatening, then the object is ignored and removed from the prioritized list of objects at step 80, and the module 36 returns to a main state at step 86 until another threat assessment is required for another object. If the object is not above the road and consequently poses a collision threat, the module 36 calculates a time to collision (TTC) at step 82, meaning the time until a collision will occur at the automobile's immediate speed.

Upon calculating the TTC, the vehicle control system 38 receives and responds to the TTC at step 84. As previously discussed, the vehicle control system 38 comprises automobile maneuvering controls 41 and passenger safety controls 42. In response to the TTC, braking and/or throttle controls may be activated to slow the automobile to a safe halt. Exemplary passenger safety controls include audible and/or visual warnings, and active passenger seats and/or seatbelts. Upon reaching a safe halt, the module 36 returns to a main state at step 86 until another threat assessment is required for another object.

Returning to the decision at step 72, if the detected object is moving then another decision is made at step 74 based on whether the automobile 10 is closing in on the object at a rate above a predetermined FVCM mode limit. If the closing rate is greater than the FVCM mode limit, then the module 36 calculates a TTC at step 82, and the vehicle control system 38 receives and responds to the TTC at step 84.

If the closing rate is less than the FVCM mode limit, then the EACC mode is reset at step 76 so the automobile 10 is able to trail the object with a minimum gap therebetween representing a safe following distance. To reset the EACC mode, an instruction is prepared by which the throttle will be reduced or released and/or the brakes are actuated until the gap between the automobile and the object reaches a minimum threshold limit, and the opening rate therebetween is greater than or equal to zero. According to the instruction, the throttle will then be increased so the automobile is maintained at a speed at which the gap is sustained. The vehicle control system 38 then receives and appropriately responds to the instruction at step 84. Upon returning the automobile 10 to a safe distance behind the object, the module 36 returns to a main state at step 86 until another threat assessment is required for another object.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1-10. (canceled)

11. An adaptive cruise control method for an automobile, comprising the steps of:
generating a first radius of curvature calculation representing a first projected vehicle path for the automobile using data from a yaw rate sensor;
generating a second radius of curvature calculation representing a second projected vehicle path for the automobile using vision sensory data from an automobile-equipped optical sensor;
weighing and combining the first and second radius of curvature calculations, and generating therefrom a third radius of curvature calculation representing a third projected vehicle path;
calculating modified yaw rate sensor data using the third radius of curvature calculation; and
controlling automobile maneuvering functions in response to the modified yaw rate sensor data.

12. The adaptive cruise control method according to claim 11, wherein controlling the automobile maneuvering functions includes controlling at least one of throttle, braking, and steering functions.

13. The adaptive cruise control method according to claim 11, further comprising:
controlling passenger safety controls in response to the modified yaw rate sensor data, the passenger safety controls comprising at least one member selected from the group consisting of audible warnings, visual warnings, active seats, and active seatbelts.

14. The adaptive cruise control method according to claim 11, further comprising:
detecting lane markings on a roadway from the vision sensory data to generate the second radius of curvature calculation.

15. The adaptive cruise control method according to claim 11, further comprising:
generating radar sensory data regarding a radar sensory field sensed by an automobile-equipped radar sensor;
detecting objects in the radar sensory field using the radar sensory data;
generating object detection and velocity data regarding the detected objects using the radar sensory data;
recognizing the objects detected by the radar sensor using the vision sensory data and the object detection data, and generating object recognition data; and
determining whether the objects identified by the radar sensor are positioned in the third projected vehicle path using the object detection and velocity data and the object recognition data.

16. The adaptive cruise control method according to claim 15, further comprising:
adjusting the radar sensor such that the radar sensory field is within the third projected vehicle path in response to the modified yaw rate sensor data.

17. The adaptive cruise control method according to claim 15, further comprising:
determining whether objects are positioned above the third projected vehicle path.

18. (canceled)

19. The adaptive cruise control method according to claim 15, further comprising:
generating instructions to the vehicle control module for responding to any recognized objects in response to the object detection data, object velocity data, and object recognition data.

20. The adaptive cruise control method according to claim 19, further comprising:
calculating a time to collision value representing the amount of time before a collision between the automobile and identified object will occur, and to generating the instructions to the vehicle control module based on the time to collision value.
